(19) United States
(12) Patent Application Publication
(10) Pub. No.: US 2023/0243137 A1
(43) Pub. Date: Aug. 3, 2023

(54) Flush Valve Apparatus

(71) Applicant: AS America, Inc., Piscataway, NJ (US)

(72) Inventors: Walter Pitsch, Washington, NJ (US); Marin Marinov, East Brunswick, NJ (US)

(73) Assignee: AS America, Inc., Piscataway, NJ (US)

(21) Appl. No.: 18/009,486

(22) PCT Filed: Jun. 29, 2021
(86) PCT No.: PCT/US21/39596

§ 371 Date: Dec. 9, 2022

Related U.S. Application Data
(60) Provisional application No. 63/045,930, filed on Jun. 30, 2020.

(51) Int. Cl. E03D 3/06; E03D 9/14; E03D 3/10; F16K 47/02; F16K 31/143; F16K 31/145

(52) U.S. Cl. CPC E03D 3/06; E03D 9/14; E03D 3/10; F16K 47/02; F16K 31/143; F16K 31/145

(57) ABSTRACT

A flush valve apparatus comprising a main body, an outer cover, an inner cover, a valve assembly, and a back-pressure chamber, wherein the outer cover is coupled to an upper end of the main body, the inner cover is positioned over the valve assembly and under the outer cover, the valve assembly comprises a valve body and is positioned at an interior of the main body, the back-pressure chamber is defined by a lower surface of the inner cover and an upper surface of the valve assembly, and wherein one or more springs are positioned substantially vertically in the back-pressure chamber. The one or more springs are effective towards minimizing flush water variation between flush cycles and towards attenuation flush valve erratic behavior.

The present invention relates to a flush valve apparatus for a toilet or urinal.

### BACKGROUND

Modern commercial toilets and urinals often include a flushometer flush valve apparatus, instead of a water tank of most residential-type toilets. A flushometer requires a large water supply line to operate properly. A flushometer uses the water pressure from a large water supply line to provide a high-pressure flush.

Flush valves typically include a diaphragm or piston separating a pressure chamber (or back-pressure chamber) from the main water supply. When a flush valve is in steady state (not cycling through a flush), water in the pressure chamber presses down on a relief valve, which presses down on the diaphragm, forcing the valve closed. To initiate a flush cycle, a lateral force is provided on a stem of a valve assembly, causing the stem to tilt. The tilt of the stem forces a relief valve open, allowing water to flow from a back-pressure chamber down through the main valve. This mechanism simultaneously creates an opening leading to a main water supply, allowing water from a main water supply to flow through the main valve and to a toilet bowl to flush the toilet. To end a flush cycle, the relief valve slowly returns to its original position, shutting off the water supply to the toilet bowl and allowing the back-pressure chamber to refill.

As a flush valve closes at the end of a flush cycle, it can sometimes generate a water hammer effect. A water hammer effect occurs when a valve closes too abruptly, causing a pressure spike. A water hammer effect can cause instability in the flush valve, manifesting in loud noise, vibrations, and in extreme situations, pipe collapse.

Further, high water pressure and/or high flush volume may result in some erratic behavior, including noise, vibrations, and the like.

An improved flush valve apparatus is desired in which such undesired effects are eliminated.

### SUMMARY

According, disclosed is a flush valve apparatus, the apparatus comprising a main body, an outer cover, an inner cover, a valve assembly, and a back-pressure chamber, wherein the outer cover is coupled to an upper end of the main body, the inner cover is positioned over the valve assembly and under the outer cover, the valve assembly comprises a valve body and is positioned at an interior of the main body, the back-pressure chamber is defined by a lower surface of the inner cover and an upper surface of the valve assembly, and wherein one or more springs are positioned substantially vertically in the back-pressure chamber.

In some embodiments, the one or more springs are effective towards attenuating a flush valve apparatus water hammer effect. In some embodiments, the one or more springs are effective towards attenuating flush valve apparatus erratic behavior selected from noise and vibration. In some embodiments, the one or more springs may minimize flush water volume variation between flush cycles. In some embodiments, the one or more springs are effective towards preventing the valve body from remaining in an open position during a flush cycle.

### BRIEF DESCRIPTION OF THE DRAWINGS

The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1A and FIG. 1B provide a perspective and exploded view of a flush valve, respectively, according to some embodiments.

FIG. 1C depicts an exploded perspective view of a valve according to some embodiments.

FIG. 1D is a cross-section view of a valve device, according to some embodiments.

FIG. 2A and FIG. 2B provide partial cross-section views of a flush valve, according to some embodiments.

FIG. 2C depicts a flush valve cover, according to an embodiment.

### DETAILED DESCRIPTION

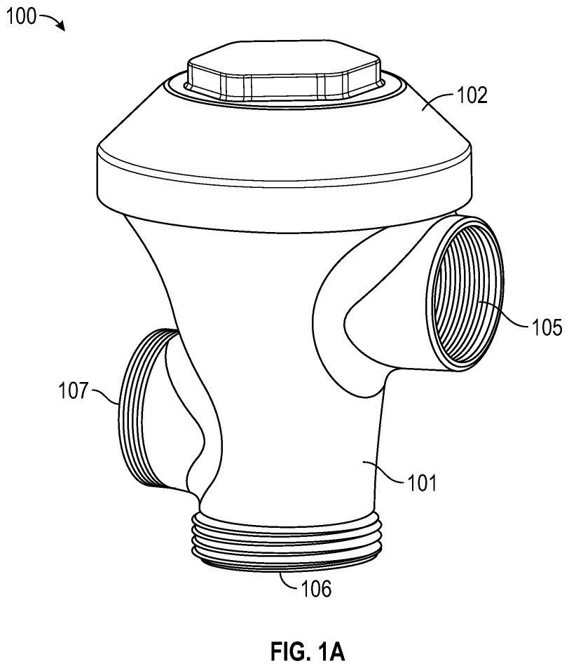

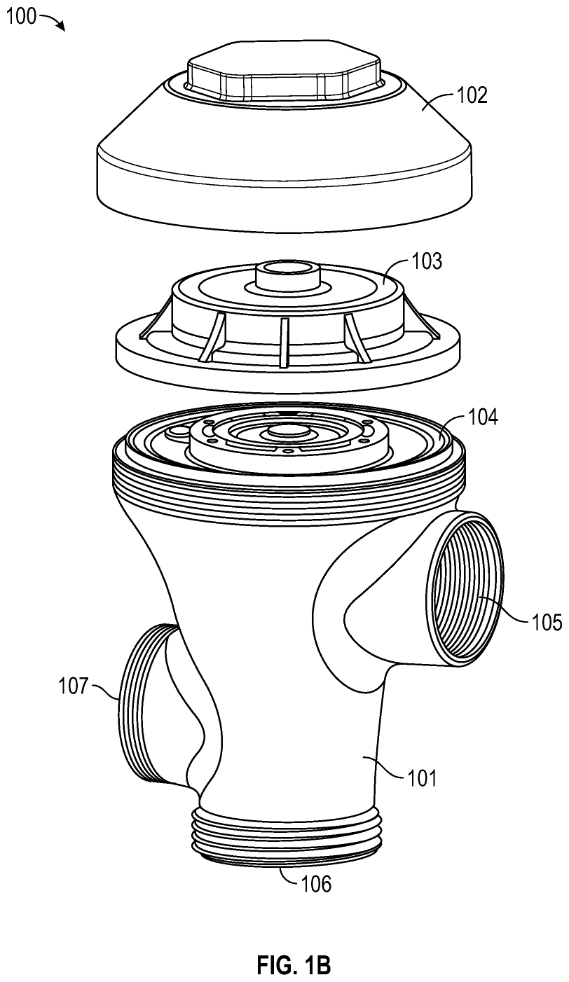

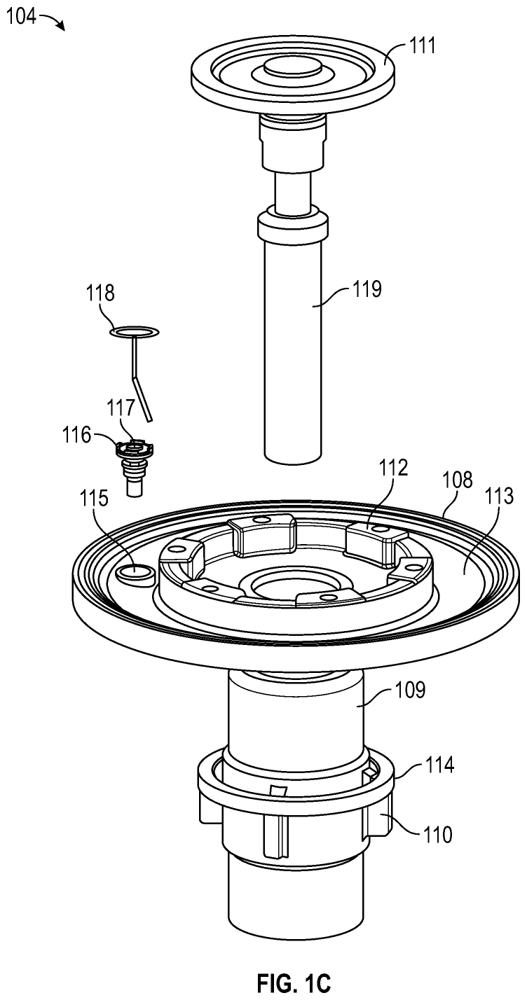

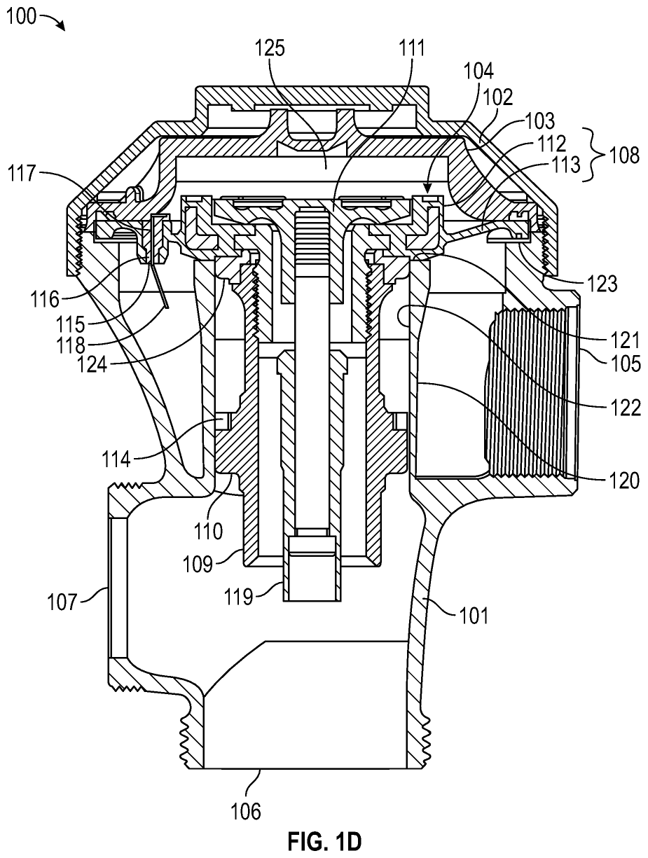

FIG. 1A and FIG. 1B provide a perspective and blown-up view of flush valve device 100, according to some embodiments. Flush valve apparatus 100 includes main body 101, outer cover 102, inner cover 103, and valve assembly 104. Outer cover 102 is coupled to an upper end of main body 101. Inner cover 103 is positioned over valve assembly 104 and under outer cover 102. Valve assembly 104 is positioned at an interior of main body 101. Main body 101 is generally cylindrical in shape and contains inlet 105, outlet 106, and operational opening 107. Inlet 105 is positioned on a side surface in an upper portion of main body 101 and is configured to be connected to source water. Outlet 106 is positioned on a bottom surface in a lower portion of main body 101 and configured to connect to a discharge pipe for discharging water. Operational opening 107 is positioned on a side surface in a middle portion of main body 101 and is configured to have an operating portion (not illustrated) attached to activate valve assembly 104. An operating portion may have an operational member such as a lever or a push button, for example. In some embodiments, an operational member may be configured to move a stem of valve assembly 104 as described below. Valve assembly 104 is assembled in main body 101, and inner cover 103 and outer cover 102 are positioned to cover valve assembly 104.

FIG. 1C is an exploded view of valve assembly 104, according to some embodiments. Valve assembly 104 includes valve body 108, sleeve pipe 109 having plate-like guides 110, and relief valve 111. Valve body 108 comprises retainer 112 for storing relief valve 111 in the center and diaphragm 113 along a peripheral edge. Retainer 112 is substantially ring-shaped and projects from an upper surface of valve body 108. Diaphragm 113 may comprise any of various materials including, but not limited to, a rubber, a resin, and/or a thermoplastic polymer. These materials may exhibit various mechanical characteristics including, but not limited to, strength, hardness, and ductility. Retainer 112 and diaphragm 113 may be formed integrally or may be formed separately and then assembled. Additionally, valve assembly 104 includes fill ring 114 located around sleeve pipe 109. Fill ring 114 is held onto sleeve pipe 109 by plate-like guides 110.

Diaphragm 113 comprises opening 115 having cylindrical member 116 positioned therein. A lower end portion of cylindrical member 116 is coupled to a lower end portion of opening 115. Cylindrical member 116 may be formed from various materials, including but not limited to, a resin, a rubber, and/or a thermoplastic polymer. In some embodiments, cylindrical member 116 may comprise a material of greater hardness than that of diaphragm 113.

Valve assembly 104 comprises refill orifice 117 formed as a substantially cylindrical hole in cylindrical member 116. Pin 118 is configured to be inserted into orifice 117. In some embodiments, a refill orifice may function sufficiently without pin 118. In some embodiments, diaphragm 113 may include only opening 115 and not cylindrical member 116 at all. Opening 115 may be configured to provide the benefits of cylindrical member 116.

In some embodiments, sleeve pipe 109 may be fixed to valve body 108. Plate-like guides 110 may project from a side surface. Relief valve 111 may be coupled to stem 119 extending downwardly. In some embodiments, stem 119 may be inserted into a center of valve body 108 from above and held in retainer 112. When a lower portion of stem 119 is pressed laterally, relief valve 111 may be tilted together with stem 119.

Fill ring 114 may be positioned around sleeve pipe 109 and held on by one or more plate-like guides 110. In some embodiments, fill ring 114 may fit loosely around sleeve pipe 109 such that it can slide up and down sleeve pipe 109. Fill ring 114 may reduce variation from flush to flush by minimizing the water volume variation between flushes. This reduction in water volume variation between flushes may eliminate some erratic behavior, particularly when operating at high pressure and/or high volume.

FIG. 1D is a cross-section view of flush valve device 100. Cylindrical inner barrel 120 is integrally provided in main body 101. Valve seat 121 is formed at an upper end of inner barrel 120. Valve opening 122 is formed by an inner peripheral edge of valve seat 121. In some embodiments, valve assembly 104 may be attached to flush valve device 100 such that sleeve pipe 109 is inserted into inner barrel 120 from above, and a peripheral edge of diaphragm 113 is positioned on shoulder 123 of an upper end portion of main body 101 and pushed by a bottom surface of a peripheral edge of inner cover 103.

Flow head 124 is positioned between a bottom surface of valve body 108 and an upper end portion of sleeve pipe 109. In some embodiments, an outer peripheral surface of flow head 124 may be removably fitted into an inner peripheral surface of an upper end portion of inner barrel 120. Valve body 108, sleeve pipe 109, and flow head 124 may move upwardly and downwardly in an integral manner. In some embodiments, guides 110 of sleeve pipe 109 may suppress any lateral swing of valve body 108, sleeve pipe 109, and/or flow head 124 in inner barrel 120.

Flow head 124 comprises a substantially annular shape. Flow head 124 may comprise a thermoplastic polymer material such as polyoxymethylene (POM), polyurethane, acrylonitrile butadiene styrene (ABS), and/or any combination thereof. Flow head 124 may be solid, or it may be hollow or otherwise comprise an internal three-dimensional lattice or honeycomb-type structure.

In some embodiments, diaphragm 113 and/or retainer 112 may have a flat, smooth, upper and/or lower surface. With a flat, smooth upper surface, a top surface of diaphragm 113 and/or retainer 112 may generate a seal with a lower surface of inner cover 103, causing the valve device to remain open indefinitely. Accordingly, diaphragm 113 and/or retainer 112 may comprise a harder plastic and/or a three-dimensional uppermost surface to minimize this sealing effect.

In an embodiment, an uppermost surface of diaphragm 113 and/or retainer 112 may be three-dimensional. One or more recesses may be disposed in an upper surface of diaphragm 113 and/or retainer 112 to create depth or dimension to the surface such that it is not flat or smooth. Diaphragm 113 of FIG. 1D shows an uppermost surface comprising not a single, horizontal surface, but instead stepping up and down several times across the width/diameter thereof and similarly with retainer 112. Accordingly, an uppermost surface of diaphragm 113 and/or retainer 112 may comprise numerous vertical, horizontal, and/or diagonal surfaces such that it is not flat or smooth along a single plane.

In an embodiment, an outer most rim of diaphragm 113 and/or retainer 112 may comprise various heights. A rim of diaphragm 113 and retainer 112 are shown in FIG. 1D in contact with a lower surface of inner cover 103, and diaphragm 113 is further in contact with shoulder 121 of an upper end portion of main body 101. A height of this outermost rim of diaphragm 113 and/or retainer 112 may be adjusted to minimize the possibility of creating a seal between an upper surface of diaphragm 113 and/or retainer 112 and inner cover 103.

In some embodiments, a fluid flow path extends from inlet 105 to outlet 106 and includes a primary flow path from inlet 105 to valve opening 122. In some embodiments, a fluid flow path includes a secondary flow path that extends from valve opening 122 through a space formed inside inner barrel 120 and outside sleeve pipe 109 to outlet 106.

Back-pressure chamber 125 is defined by a lower surface of inner cover 103 and an upper surface of valve assembly 104. Orifice 117 allows a primary flow path and back-pressure chamber 125 to fluidly communicate and form a flow path in the space between an inner peripheral surface of orifice 117 and an outer peripheral surface of pin 118.

Valve assembly 100 includes fill ring 114 located around sleeve pipe 109 of valve assembly 104. Fill ring 114 may be loose around sleeve pipe 109 to allow for movement up and down sleeve pipe 109. One or more guides 110 may prevent fill ring 114 from sliding down and off sleeve pipe 109. In some embodiments, fill ring 114 may help reduce variation between flushes. Particularly, fill ring 114 may serve to eliminate some erratic behavior from flush to flush of valve assembly 100.

Flush valve assembly 100 includes refill orifice 117. Refill orifice 117 may include pin 118 therein. Some embodiments may not include pin 118 within orifice 117, and may instead include another suitable mechanism for cleaning small hole 117. In addition, in some embodiments, diaphragm 113 may include only opening 115 and not cylindrical member 116 at all. Opening 115 may be configured to provide the benefits of cylindrical member 116.

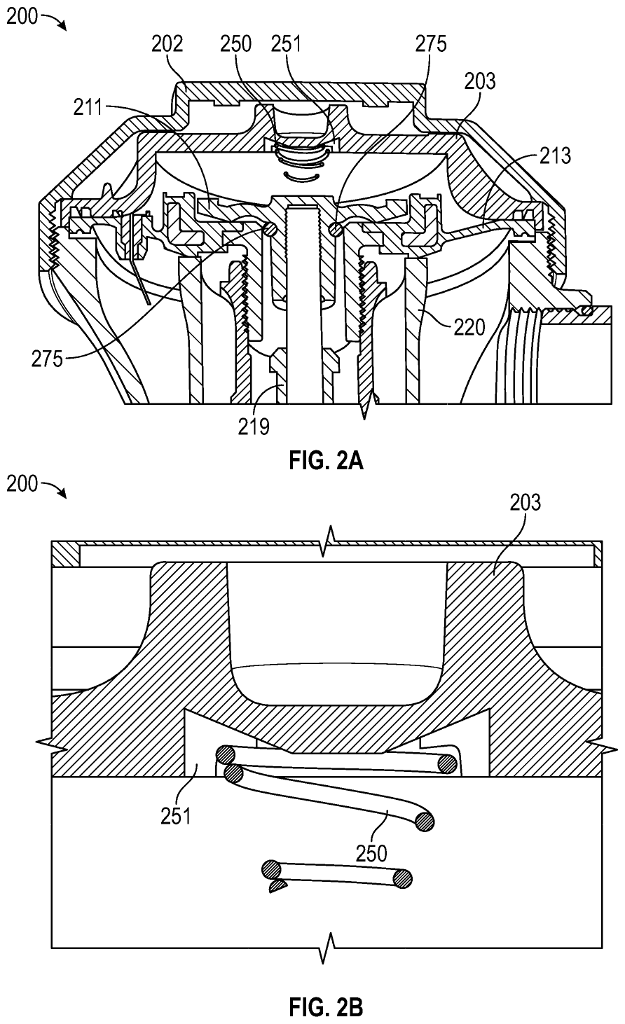

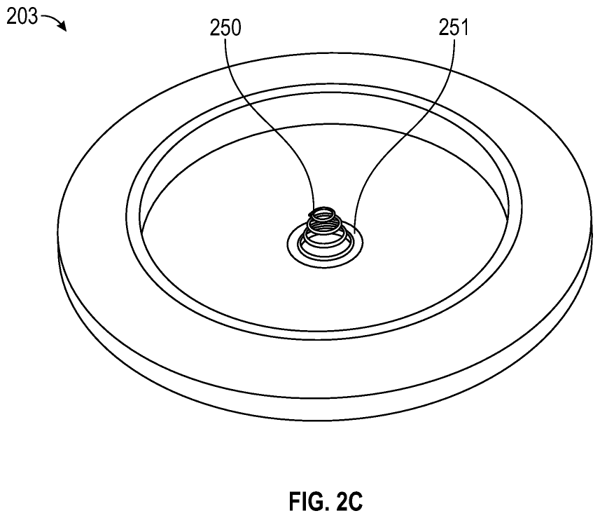

FIG. 2A and FIG. 2B provide partial cross-section views of flush valve assembly 200, according to some embodiments. Compression spring 250 is positioned substantially centered in an underside of inner cover 203 and held in place with housing 251. Compression spring is positioned vertically in back-pressure chamber 225. Spring 250 is confined-space conical compression spring. Visible are outer cover 202, inlet 205, relief valve 211, retainer 212, diaphragm 213, stem 219, inner barrel 220, and gasket 275.

FIG. 2C depicts flush valve inner cover 203, according to an embodiment. From an underside view, spring 250 and spring housing 251 are seen substantially centered in flush valve cover 203.

Some flush valves are described for example in U.S. app. Nos. PCT/US2019/032840 and PCT/US2019/046603.

In some embodiments, “substantially vertically” in relation to a position may mean “vertical or about vertical”. In some embodiments, “substantially centered” may mean “centered or about centered”.

In some embodiments, a flush valve apparatus may comprise a main body, an outer cover, an inner cover, a valve assembly, and a back-pressure chamber. A main body may comprise a general cylinder-like shape, and have an inlet, an outlet, and an operational opening. A valve assembly inlet may be positioned on a side of the main body and may be fluidly coupled to a water source. A valve assembly outlet may be positioned at a bottom end of the main body and may be fluidly coupled to a basin of a toilet or urinal via a discharge pipe. Operational opening may be positioned at a side of the main body and may be configured to receive and couple to an operational member such as a lever, button, automatic actuator, and the like.

In some embodiments, an outer cover is positioned on a top of a flush valve assembly and an inner cover is positioned under the outer cover. An inner cover may be coupled to an outer cover. A valve assembly may be positioned below an inner cover. In some embodiments, an outer cover/inner cover assembly may be positioned over and cover a valve assembly. A back-pressure chamber may be defined by a space between an inner cover lower surface and a valve assembly upper surface.

In some embodiments, an operational member may be configured to provide a lateral force on a stem of a valve assembly, causing the stem to tilt. The tilt of the stem forces a relief valve open, allowing water to flow from a back-pressure chamber down through the main body. This mechanism simultaneously creates an opening leading to a source water supply, allowing source water to flow through the main body and to a toilet or urinal basin to flush the basin. To end a flush cycle, the relief valve and valve assembly slowly return to their original position, shutting off the water supply to the apparatus and allowing the back-pressure chamber to refill.

In some embodiments, the valve body is configured to be in an open position or a closed position. In an open position, a diaphragm of a valve body is lifted off a valve seat and a valve apparatus inlet is in fluid communication with a valve apparatus outlet, providing a flush. As the diaphragm re-seats on the valve seat, ending a flush cycle. When the valve body is in an open position, the valve apparatus is in an open position and is configured to allow fluid flow through a main body outlet to a basin of a toilet or urinal. When the valve body is in a closed position, the valve apparatus is in a closed position and there is no fluid flow through a main body outlet—the valve apparatus is “at rest”.

In some embodiments, a spring may be a compression spring, a flexible rubber part (e.g. a flexible rubber cylinder), a hydraulic spring, and the like. In some embodiments, a spring may be a confined-space conical compression spring. In some embodiments, a conical compression spring may have a larger diameter end coupled to an inner cover. In other embodiments, a conical compression spring may have a larger diameter end coupled to an upper surface of a valve assembly.

In certain embodiments, a larger diameter end of a conical spring may have an outer diameter of from any of about 0.40 inches, about 0.45 inches, or about 0.50 inches, to any of about 0.55 inches, about 0.60 inches, about 0.65 inches, about 0.70 inches, about 0.75 inches, about 0.80 inches, or more. In some embodiments, a smaller diameter end of a conical spring may have an outer diameter of from any of about 0.11 inches, about 0.15 inches, or about 0.20 inches, to any of about 0.25 inches, about 0.30 inches, about 0.31 inches, about 0.35 inches, about 0.40 inches, about 0.45 inches, or more. In some embodiments, a spring may comprise an overall “at rest” length of from any of about 0.18 inches, about 0.23 inches, or about 0.28 inches, to any of about 0.33 inches, about 0.38 inches, about 0.43 inches, about 0.48 inches, about 0.53 inches, about 0.58 inches, or more. In some embodiments, a spring may have a compressed length of from any of about 0.04 inches, about 0.05 inches, or about 0.06 inches, to any of about 0.07 inches, about 0.08 inches, about 0.09 inches, about 0.10 inches, about 0.11 inches, about 0.12 inches, or more. In some embodiments, a spring may have a wire diameter of from any of about 0.018 inches, about 0.021 inches, or about 0.024 inches, to any of about 0.027 inches, about 0.030 inches, about 0.033 inches, about 0.036 inches, about 0.039 inches, about 0.042 inches, about 0.045 inches, about 0.048 inches, about 0.051 inches, about 0.054 inches, about 0.057 inches, or more.

In some embodiments, a spring may serve to reduce variation from flush to flush, for instance by pushing down on a valve assembly and to minimize water volume variation between flushes. A reduction in water volume variation between flushes may eliminate some erratic behavior which may result from high water pressure and/or high flush volume.

A spring positioned substantially vertically may mean that the spring is substantially aligned along a length of a flush valve apparatus. In such a configuration, a “spring action” may take place between a lower surface of an inner cover and an upper surface of a valve assembly. That is, when an inner cover and a valve assembly approach each other, a spring will be compressed, and when an inner cover and a valve assembly move away from each other, a spring will expand to a resting position. A spring may help return a valve assembly to a closed, resting position.

In some embodiments, a spring may be coupled to a lower surface of an inner cover. In other embodiments, a spring may be coupled to an upper surface of a valve assembly, for instance coupled to an upper surface of a relief valve. In some embodiments, a spring may be coupled to both a lower surface of an inner cover and an upper surface of a valve assembly.

In some embodiments, when the valve body is in a closed position and the valve apparatus is at rest, the one or more springs are in contact with a lower surface of the inner cover and with an upper surface of the valve assembly.

In other embodiments, when the valve body is in a closed position and the valve apparatus is at rest, the one or more springs are coupled to a lower surface of the inner cover and are not in contact with an upper surface of the valve assembly.

In yet other embodiments, when the valve body is in a closed position and the valve apparatus is at rest, the one or more springs are coupled to an upper surface of the valve assembly, for example to an upper surface of a relief valve, and are not in contact with a lower surface of the inner cover.

In other embodiments, when the valve body is in a closed position and the valve apparatus is at rest, the one or more springs are coupled to a lower surface of the inner cover and coupled to an upper surface of the valve assembly.

In some embodiments, a spring may be positioned substantially centered in a back-pressure chamber. In some embodiments, a spring may be positioned substantially centered in an underside of an inner cover. In some embodiments, a spring may be held in place with a spring housing. In other embodiments, an inner cover may be molded such that a spring fits snugly in the cover itself and no separate housing is needed.

In some embodiments, a valve assembly may include a valve body, a sleeve pipe, and a relief valve. A sleeve pipe may comprise plate-like guides. A valve body may comprise a retainer configured to store a relief valve in its center and a diaphragm positioned along a peripheral edge. In some embodiments, a retainer may be substantially ring-shaped and may project from an upper surface of a valve body. A diaphragm may comprise any of various materials including, but not limited to, a rubber, a resin, and/or a thermoplastic polymer. These materials may exhibit various mechanical characteristics including, but not limited to, strength, hardness, and ductility. A retainer and diaphragm may be formed integrally or may be formed separately and then assembled. A valve assembly may also include a fill ring positioned about a sleeve pipe. A fill ring may be held onto a sleeve pipe via plate-like guides.

A diaphragm may comprise an opening having a cylindrical member positioned therein. A lower end portion of the cylindrical member may be coupled to a lower end portion of the opening. A cylindrical member may be formed from various materials, including but not limited to, a resin, a rubber, and/or a thermoplastic polymer. In some embodiments, a cylindrical member may comprise a material of greater hardness than that of a diaphragm.

A valve assembly may comprise a refill orifice formed as a substantially cylindrical hole in a cylindrical member. A pin may be configured to be inserted into a refill orifice. In some embodiments, a refill orifice may function sufficiently without a pin. In some embodiments, a diaphragm may include only an opening and no a cylindrical member at all. An opening may be configured to provide the benefits of a cylindrical member.

In some embodiments, a sleeve pipe may be fixed to a valve body. Plate-like guides may project from a side surface thereof. A relief valve may be coupled to a stem extending downwardly. In some embodiments, a stem may be inserted into a center of a valve body from above and held in a retainer. When a lower portion of a stem is pressed laterally, a relief valve may be tilted together with a stem.

A fill ring may be positioned around a sleeve pipe and held on by one or more plate-like guides. In some embodiments, a fill ring may fit loosely around a sleeve pipe such that it can slide up and down the sleeve pipe. A fill ring may reduce variation from flush to flush by helping to minimize the water volume variation between flushes. This reduction in water volume variation between flushes may eliminate some erratic behavior, particularly when operating at high pressure and/or high volume.

In some embodiments, a valve apparatus may comprise a cylinder-like inner barrel in a main body. A valve seat may be formed at an upper end of the inner barrel. A valve opening is formed by an inner peripheral edge of the valve seat as a valve body is lifted during a flush cycle. In some embodiments, a valve assembly may be attached to a flush valve apparatus such that a sleeve pipe is inserted into an inner barrel from above, and a peripheral edge of a diaphragm is positioned on a shoulder of an upper end portion of the main body and pushed downward by a bottom surface of a peripheral edge of an inner cover.

In some embodiments, a flow head may be positioned between a bottom surface of a valve body and an upper end portion of a sleeve pipe. In some embodiments, an outer peripheral surface of a flow head may be removably fitted into an inner peripheral surface of an upper end portion of an inner barrel. A valve body, a sleeve pipe, and a flow head may move upwardly and downwardly in an integral manner during a flush cycle. In some embodiments, guides of a sleeve pipe may function towards suppressing any lateral swing of a valve body, sleeve pipe, and/or flow head in an inner barrel.

In some embodiments, a flow head may comprise a substantially annular shape. In some embodiments, a flow head may comprise a thermoplastic polymer material such as polyoxymethylene (POM), polyurethane, acrylonitrile butadiene styrene (ABS), and/or any combination thereof. A flow head may be solid, or it may be hollow or otherwise comprise an internal three-dimensional lattice or honeycomb-type structure.

In some embodiments, a diaphragm and/or a retainer may have a flat, smooth, upper and/or lower surface. With a flat, smooth upper surface, a top surface of a diaphragm and/or a retainer may generate a seal with a lower surface of an inner cover, causing the valve apparatus to remain in an open position. In some embodiments, a diaphragm and/or a retainer may comprise a harder plastic and/or a three-dimensional uppermost surface to minimize this sealing effect. A spring of the present invention may also serve to prevent a valve body from remaining or getting “stuck” in an open position during a flush cycle.

In an embodiment, an uppermost surface of a diaphragm and/or a retainer may comprise a three-dimensional surface. In some embodiments, one or more recesses may be disposed in an upper surface of a diaphragm and/or a retainer to create depth or dimension to the surface such that it is not flat or smooth. In an embodiment, an outer most rim of a diaphragm and/or a retainer may comprise various heights. A height of an outermost rim of a diaphragm and/or a retainer may be adjusted to minimize a possibility of creating an undesired seal between an upper surface of a diaphragm and/or a retainer and an inner cover.

In some embodiments, a fluid flow path extends from a main body inlet to a main body outlet and includes a primary flow path from inlet to a valve opening. In some embodiments, a fluid flow path includes a secondary flow path that extends from a valve opening through a space formed inside an inner barrel and outside a sleeve pipe to an outlet.

In some embodiments, a back-pressure chamber may be defined by a fluid flow path between an upper surface of a valve body and an interior wall of an inner cover. A refill orifice allows a primary flow path and back-pressure chamber to fluidly communicate and form a flow path in the space between an inner peripheral surface of the orifice and an outer peripheral surface of a pin. In some embodiments, a pin is not required.

In some embodiments, a valve assembly includes fill ring located around a sleeve pipe. A fill ring may be loose around a sleeve pipe to allow for up and down movement. In some embodiments, one or more guides may prevent a fill ring from sliding down and off a sleeve pipe. In some embodiments, a fill ring may help reduce variation between flush cycles. In some embodiments, a fill ring may serve to eliminate some erratic behavior from flush cycle to flush cycle.

In some embodiments, a flush valve assembly includes a refill orifice. A refill orifice may include pin therein. Some embodiments may not include a pin within a refill orifice, and may instead include another suitable mechanism for cleaning the small orifice. In addition, in some embodiments, a diaphragm may include only an opening and no cylindrical member comprising a refill orifice at all. An opening may be configured to provide the benefits of a cylindrical member having a refill orifice.

Following are some non-limiting embodiments of the disclosure.

In a first embodiment, disclosed is flush valve apparatus, comprising a main body, an outer cover, an inner cover, a valve assembly, and a back-pressure chamber wherein the outer cover is coupled to an upper end of the main body, the inner cover is positioned over the valve assembly and under the outer cover, the valve assembly comprises a valve body and is positioned at an interior of the main body, the back-pressure chamber is defined by a lower surface of the inner cover and an upper surface of the valve assembly, and wherein one or more springs are positioned vertically or substantially vertically in the back-pressure chamber.

In a second embodiment, disclosed is a flush valve apparatus according to the first embodiment, wherein the one or more springs comprise compression springs. In a third embodiment, disclosed is a flush valve apparatus according to embodiments 1 or 2, wherein the one or more springs comprise a conical compression spring. In a fourth embodiment, disclosed is a flush valve apparatus according to any of the preceding embodiments, wherein the one or more springs comprise a confined-space conical compression spring.

In a fifth embodiment, disclosed is a flush valve apparatus according to any of embodiments 1 to 4, wherein the valve body is configured to open and close, and when the valve body is in a closed position, the one or more springs are in contact with the lower surface of the inner cover and with the upper surface of the valve assembly.

In a sixth embodiment, disclosed is a flush valve apparatus according to any of embodiments 1 to 4, wherein the valve body is configured to open and close, and when the valve body is in a closed position, the one or more springs are coupled to the lower surface of the inner cover and are not in contact with the upper surface of the valve assembly.

In a seventh embodiment, disclosed is a flush valve apparatus according to any of embodiments 1 to 4, wherein the valve body is configured to open and close, and when the valve body is in a closed position, the one or more springs are coupled to the upper surface of the valve assembly and are not in contact with the lower surface of inner cover.

In an eighth embodiment, disclosed is a flush valve apparatus according to any of embodiments 1 to 6, wherein a spring is coupled to the lower surface of the inner cover. In a ninth embodiment, disclosed is a flush valve apparatus according to any of embodiments 1 to 6, wherein the one or more springs are received by a spring housing, and the spring housing is positioned in a recess in the inner cover lower surface.

In a tenth embodiment, disclosed is a flush valve apparatus according to any of the preceding embodiments, comprising a spring centered or substantially centered in the back-pressure chamber. In an eleventh embodiment, disclosed is a flush valve apparatus according to any of the preceding embodiments, wherein the one or more springs are received by a spring housing.

In a twelfth embodiment, disclosed is a flush valve apparatus according to any of the preceding embodiments, wherein the valve body comprises a diaphragm, and wherein the upper surface of the valve assembly comprises an upper surface of the diaphragm.

In a thirteenth embodiment, disclosed is a flush valve apparatus according to any of embodiments 1 to 11, wherein the valve body comprises a piston, and wherein the upper surface of the valve assembly comprises an upper surface of the piston.

In a fourteenth embodiment, disclosed is a flush valve apparatus according to any of the preceding embodiments, wherein the valve assembly comprises a relief valve, and wherein the upper surface of the valve assembly comprises an upper surface of the relief valve.

In a fifteenth embodiment, disclosed is a flush valve apparatus according to any of the preceding embodiments, wherein the one or more springs are effective towards attenuating a flush valve apparatus water hammer effect. In a sixteenth embodiment, disclosed is a flush valve apparatus according to any of the preceding embodiments, wherein the one or more springs are effective towards attenuating flush valve apparatus erratic behavior selected from noise and vibration.

In a seventeenth embodiment, disclosed is a flush valve apparatus according to any of the preceding embodiments, wherein the one or more springs are effective towards minimizing flush water volume variation between flush cycles. In an eighteenth embodiment, disclosed is a flush valve apparatus according to any of the preceding embodiments, wherein the valve body is configured to open and close, wherein the one or more springs are effective towards preventing the valve body from remaining in an open position during a flush cycle.

The term “adjacent” may mean “near” or “close-by” or “next to”.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through and may be synonymous with “fluidly coupled” or “fluid communication”. The terms “upstream” and “downstream” indicate a direction of gas or fluid flow, that is, gas or fluid will flow from upstream to downstream.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90° ”. The term “generally” may be equivalent to “substantially”.

All U.S. patent applications, published patent applications and patents referred to herein are hereby incorporated by reference.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. A flush valve apparatus, comprising a main body, an outer cover, an inner cover, a valve assembly, and a back-pressure chamber wherein
the outer cover is coupled to an upper end of the main body,
the inner cover is positioned over the valve assembly and under the outer cover,
the valve assembly comprises a valve body and is positioned at an interior of the main body,
the back-pressure chamber is defined by a lower surface of the inner cover and an upper surface of the valve assembly, and
wherein one or more springs are positioned substantially vertically in the back-pressure chamber.

2. The flush valve apparatus according to claim 1, wherein the one or more springs comprise compression springs.

3. The flush valve apparatus according to claim 1, wherein the one or more springs comprise a conical compression spring.

4. The flush valve apparatus according to claim 1, wherein the one or more springs comprise a confined-space conical compression spring.

5. The flush valve apparatus according to claim 1, wherein the valve body is configured to open and close, and when the valve body is in a closed position, the one or more springs are in contact with the lower surface of the inner cover and with the upper surface of the valve assembly.

6. The flush valve apparatus according to claim 1, wherein the valve body is configured to open and close, and when the valve body is in a closed position, the one or more springs are coupled to the lower surface of the inner cover and are not in contact with the upper surface of the valve assembly.

7. The flush valve apparatus according to claim 1, wherein the valve body is configured to open and close, and when the valve body is in a closed position, the one or more springs are coupled to the upper surface of the valve assembly and are not in contact with the lower surface of the inner cover.

8. The flush valve apparatus according to claim 1, wherein a spring is coupled to the lower surface of the inner cover.

9. The flush valve apparatus according to claim 1, wherein the one or more springs are received by a spring housing, and the spring housing is positioned in a recess in the inner cover lower surface.

10. The flush valve apparatus according to claim 1, comprising a spring substantially centered in the back-pressure chamber.

11. The flush valve apparatus according to claim 1, wherein the one or more springs are received by a spring housing.

12. The flush valve apparatus according to claim 1, wherein the valve body comprises a diaphragm, and wherein the upper surface of the valve assembly comprises an upper surface of the diaphragm.

13. The flush valve apparatus according to claim 1, wherein the valve body comprises a piston, and wherein the upper surface of the valve assembly comprises an upper surface of the piston.

14. The flush valve apparatus according to claim 1, wherein the valve assembly comprises a relief valve, and wherein the upper surface of the valve assembly comprises an upper surface of the relief valve.

15. The flush valve apparatus according to claim 1, wherein the one or more springs are effective towards attenuating a flush valve apparatus water hammer effect.

16. The flush valve apparatus according to claim 1, wherein the one or more springs are effective towards attenuating flush valve apparatus erratic behavior selected from noise and vibration.

17. The flush valve apparatus according to claim 1, wherein the one or more springs are effective towards minimizing flush water volume variation between flush cycles.

18. The flush valve apparatus according to claim 1, wherein the valve body is configured to open and close, wherein the one or more springs are effective towards preventing the valve body from remaining in an open position during a flush cycle.
